(19) United States
(12) Patent Application Publication
(10) Pub. No.: US 2025/0176563 A1
(43) Pub. Date: Jun. 5, 2025

(54) OVEN INCLUDING DUAL GAS BURNER

(71) Applicant: Napoli LLC, Woodbury, MN (US)

(72) Inventor: Eric Thomas Bert, Woodbury, MN (US)

(21) Appl. No.: 18/965,284

(22) Filed: Dec. 2, 2024

Related U.S. Application Data
(60) Provisional application No. 63/605,677, filed on Dec. 4, 2023.

(51) Int. Cl. A21B 1/28; A21B 1/44; A21B 5/00

(52) U.S. Cl. CPC A21B 1/28; A21B 1/44; A21B 5/00

(57) ABSTRACT

An example oven can include: a main body defining a cooking cavity; a front portion of the main body defining a front opening for receiving a pizza; a baking stone positioned to support the pizza; and a gas burner positioned adjacent to the baking stone; wherein the gas burner includes a lower burner tube positioned to heat the baking stone; and wherein the gas burner includes an upper burner tube positioned to create a rolling flame over a top portion of the pizza.

### RELATED APPLICATIONS

This patent application is related to U.S. patent application Ser. No. 16/556,274 filed on Aug. 30, 2019 and U.S. patent application Ser. No. 17/456,181 filed on Nov. 23, 2021, the entireties of which are hereby incorporated by reference.

### INTRODUCTION

The quest to cook the perfect Neapolitan style pizza with a light, crispy crust is a never-ending journey. Restaurants construct large, wood-filled brick ovens that are maintained at the high temperatures necessary to cook these pizzas. However, it is difficult and cost-prohibitive for individuals to create the proper cooking environment at home or on the go. This can result less-then-optimal conditions that cause the pizza to be over-or under-cooked.

### SUMMARY

In one aspect, an example oven includes: a main body defining a cooking cavity; a front portion of the main body defining a front opening for receiving a pizza; a baking stone positioned to support the pizza; and a gas burner positioned adjacent to the baking stone; wherein the gas burner includes a lower burner tube positioned to heat the baking stone; and wherein the gas burner includes an upper burner tube positioned to create a rolling flame over a top portion of the pizza.

Other configurations are possible.

### DESCRIPTION OF THE FIGURES

FIG. 1 shows an example oven configured to use multiple fuel sources.

FIG. 2 shows additional aspects of the oven of FIG. 1.

FIG. 3 shows additional aspects of the oven of FIG. 1.

FIG. 4 shows a cross-sectional view of the oven of FIG. 1.

FIG. 5 shows an example wood burning tray assembly of the oven of FIG. 1.

FIG. 6 shows additional aspects of the wood burning tray assembly of FIG. 5.

FIG. 7 shows additional aspects of the wood burning tray assembly of FIG. 5.

FIG. 8 shows an example gas burner of the oven of FIG. 1.

FIG. 9 shows additional aspects of the gas burner of FIG. 8.

FIG. 10 shows the wood burning tray assembly and the gas burner of the oven of FIG. 1 in isolation in an uncoupled state.

FIG. 11 shows the wood burning tray assembly and the gas burner of the oven of FIG. 1 in isolation in a coupled state.

FIG. 12 shows the wood burning tray assembly and the gas burner of the oven of FIG. 11 with wood.

FIG. 13 shows the wood burning tray assembly being inserted into the oven of FIG. 1.

FIG. 14 shows additional aspects of the oven of FIG. 1.

FIG. 15 shows additional aspects of the oven of FIG. 1.

FIG. 16 shows additional aspects of the oven of FIG. 1.

FIG. 17 shows additional aspects of the oven of FIG. 1.

FIG. 18 shows additional aspects of the oven of FIG. 1.

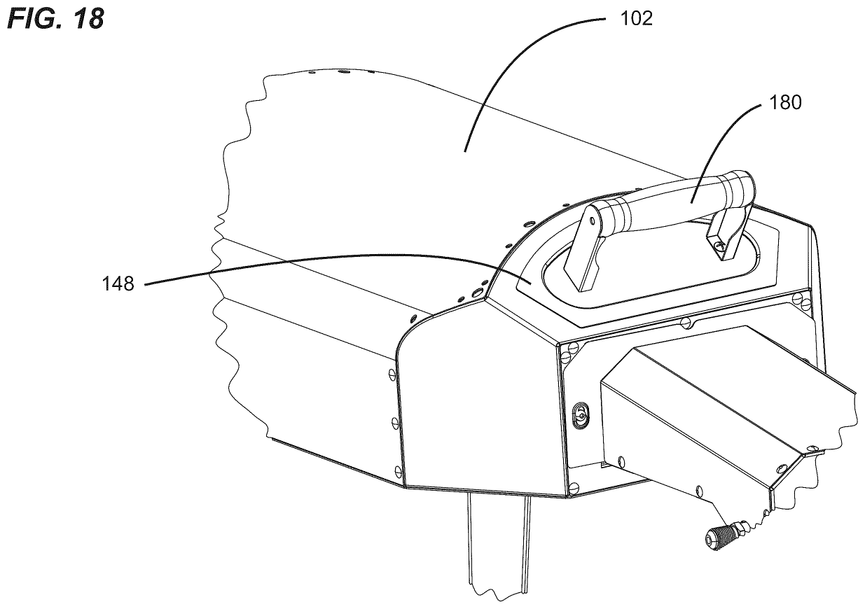

FIG. 19 shows another example oven configured to use multiple fuel sources.

FIG. 20 shows additional aspects of the oven of FIG. 19.

FIG. 21 shows additional aspects of the oven of FIG. 19.

FIG. 22 shows additional aspects of the oven of FIG. 19.

FIG. 23 shows a cross-sectional view of the oven of FIG. 19.

FIG. 24 shows additional aspects of the oven of FIG. 19 with some components being removed or transparent.

FIG. 25 shows an enlarged view of a portion of FIG. 23.

FIG. 26 shows additional aspects of the oven of FIG. 19 with some components being removed or transparent.

FIG. 27 shows an example wood burning tray assembly of the oven of FIG. 19.

FIG. 28 shows additional aspects of the wood burning tray assembly of FIG. 27.

FIG. 29 shows additional aspects of the wood burning tray assembly of FIG. 27.

FIG. 30 shows additional aspects of the wood burning tray assembly of FIG. 27.

FIG. 31 shows an example grate of the wood burning tray assembly of FIG. 27.

FIG. 32 shows an example of a baking stone with a rotating portion.

FIG. 33 shows another example of a baking stone with a rotating portion.

FIG. 34 shows an example wood burning tray assembly of the oven of FIG. 19.

FIG. 35 shows aspects of another example oven with some components being removed or transparent.

FIG. 36 shows the gas burner of the oven of FIG. 35 in isolation.

FIG. 37 shows another view of the gas burner of FIG. 36.

FIG. 38 shows another view of the gas burner of FIG. 36.

FIG. 39 shows aspects of another example oven.

FIG. 40 shows another view of the oven of FIG. 39.

FIG. 41 shows another view of the oven of FIG. 39.

FIG. 42 shows another view of the oven of FIG. 39 with an example door open.

FIG. 43 shows another view of the oven of FIG. 39 with some components being removed or transparent.

### DETAILED DESCRIPTION

In examples provided herein, an oven is provided to cook various food items. In these examples, the oven can be generally rectangular and used to cook a pizza, such a Neapolitan style pizza.

The oven can use a variety of fuel types, including gas (propane), natural gas, wood, charcoal, and/or wood pellets, to heat up to 900+ degrees Fahrenheit in a short amount of time. One example of an oven that can use a variety of fuel types (e.g., wood and gas) is provided in U.S. Patent Application No. 62/608,185 filed on Dec. 20, 2017.

In the examples provided herein, the oven allows one to use multiple fuel sources to cook. In one example, this includes using both gas and wood fuel sources at the same time. Generally, a gas burner provides a quick, reliable source of heat. The gas burner, in turn, can be used to ignite and burn wood placed in the oven adjacent to the gas burner.

In the provided examples, the gas burner slides into the specially designed wood tray, allowing one to put wood on top of the gas burner. This allows the gas burner to quickly heat the oven and maintain a consistent temperature. Then, one can add wood to the oven, which can be ignited by the gas burner. The wood provides that natural, smoky wood flavor in the pizza. The embodiments provided herein maintain the burning of the wood because the gas burner is provided adjacent to (e.g., below) the wood.

Additional details for the example oven are provided in the accompanying drawings, which are hereby incorporated by reference in their entirety.

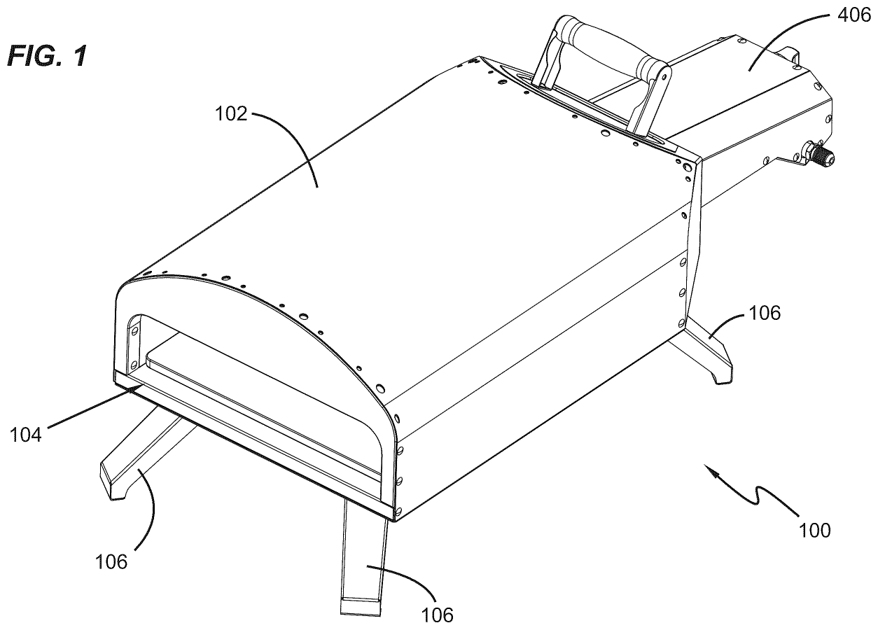

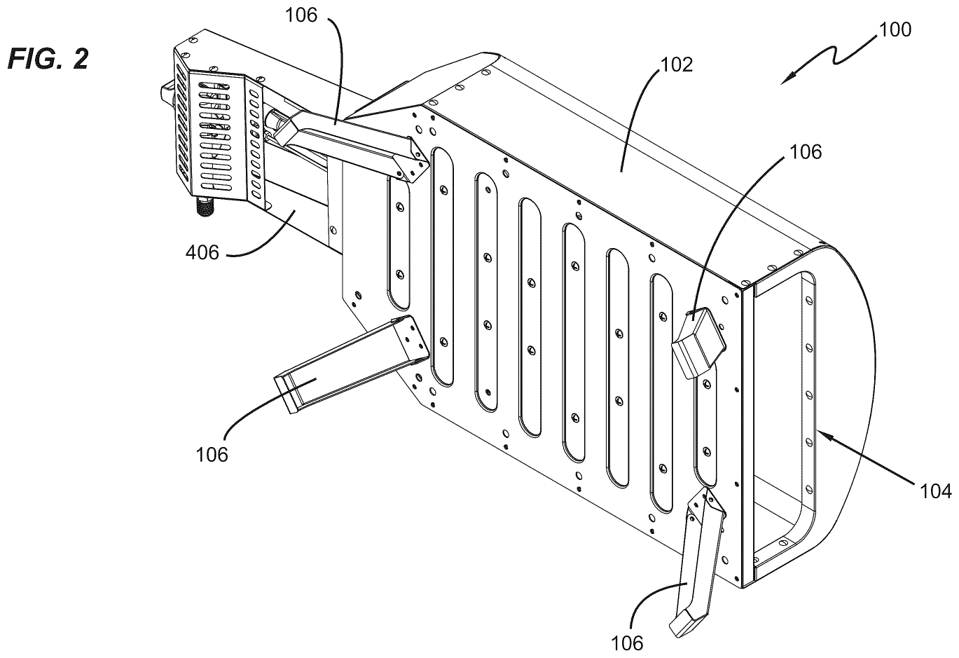

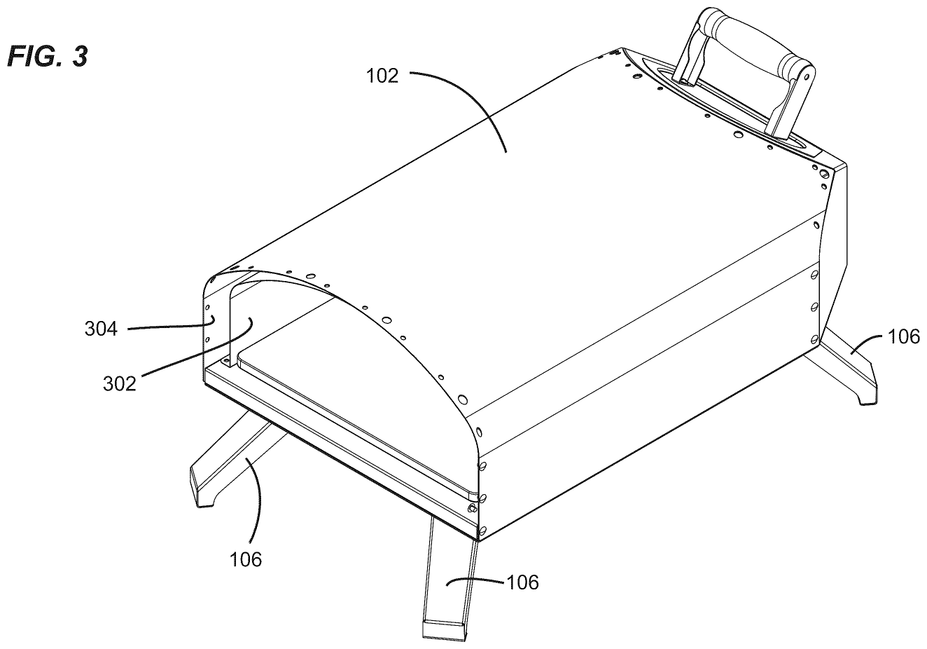

Referring now to FIGS. 1-4, an example oven 100 is shown. The oven 100 includes a generally rectangular body 102 formed of an inner shell 302 and an outer shell 304. The body 102 forms a cooking cavity 482 therein. In this example, a layer of insulation can be positioned between the inner shell 302 and the outer shell 304 to help maintain a more consistent temperature for the cooking cavity 482.

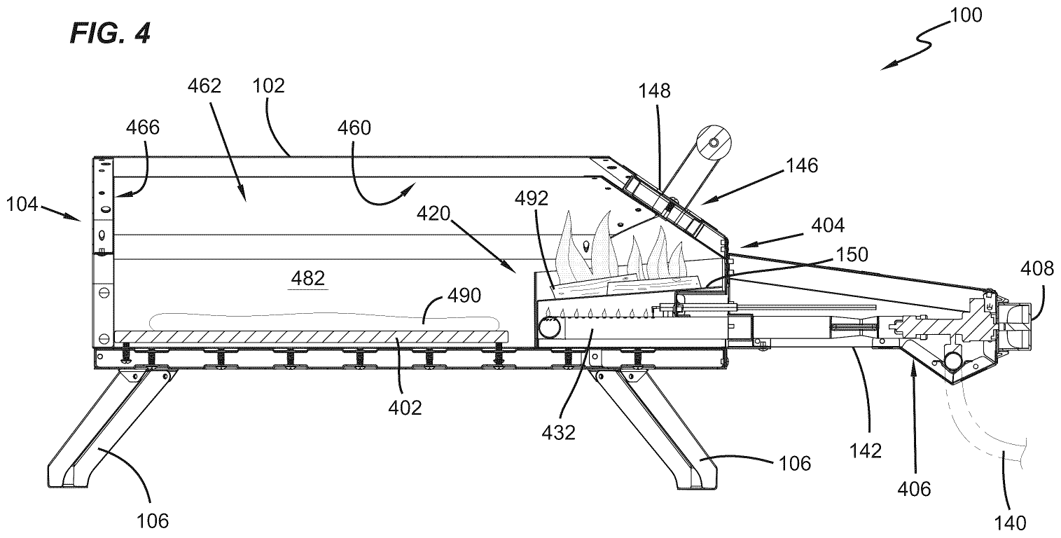

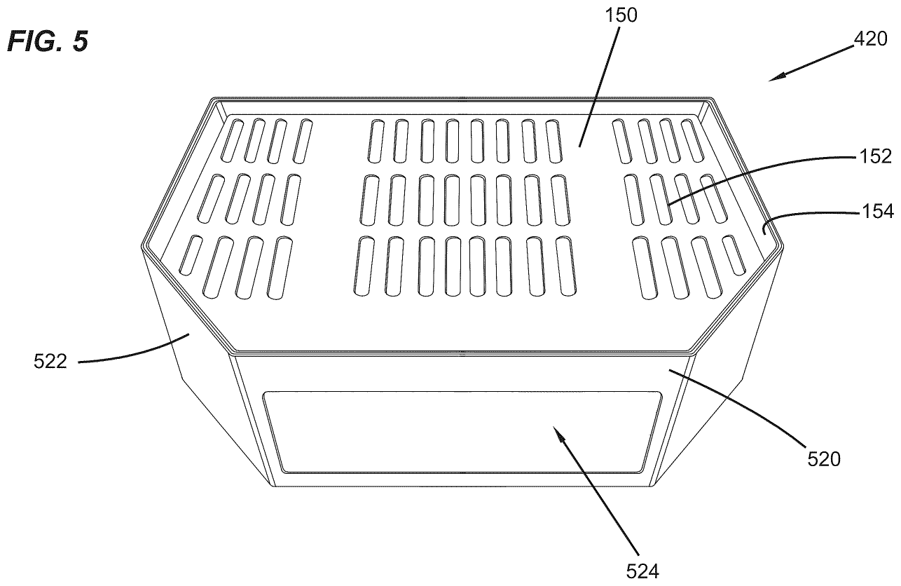

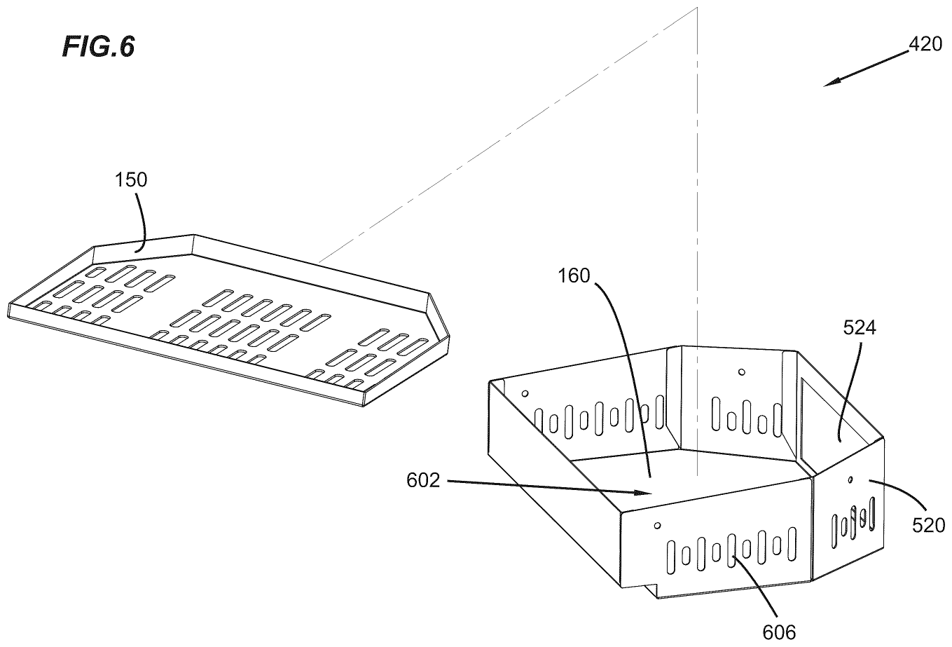

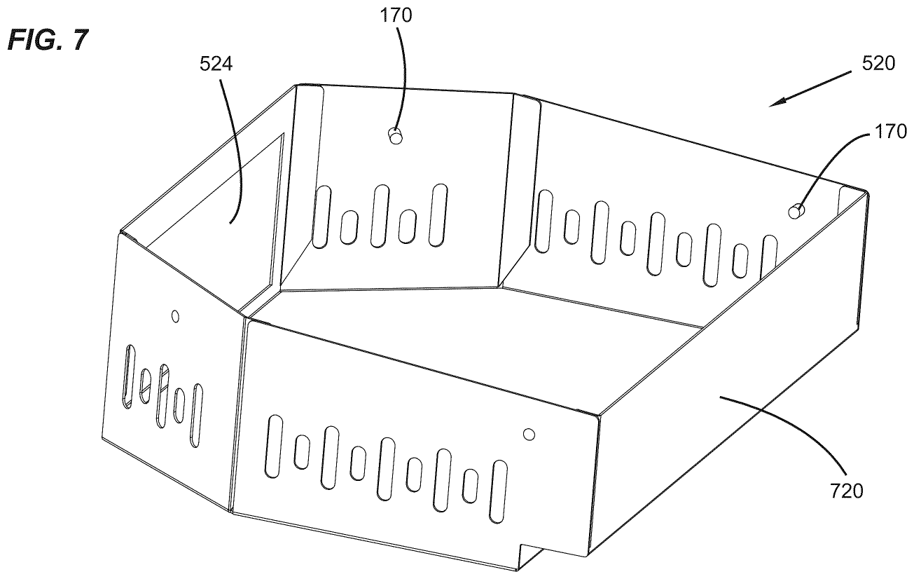

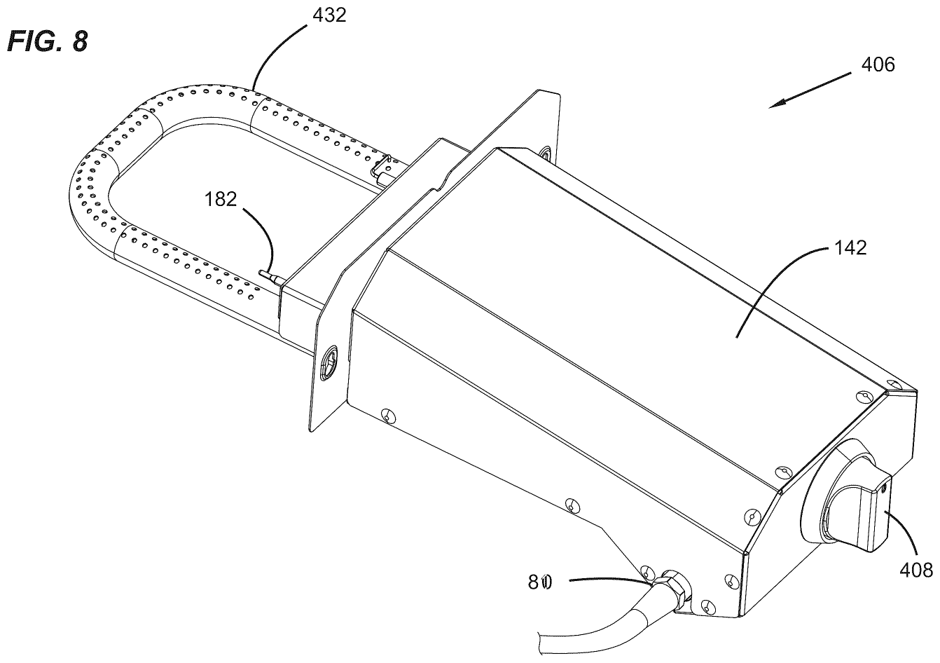

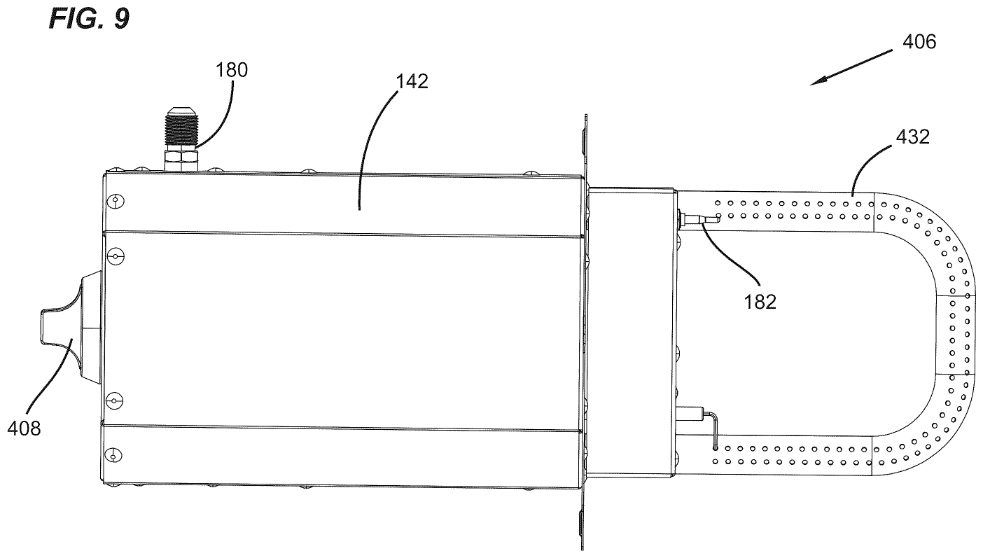

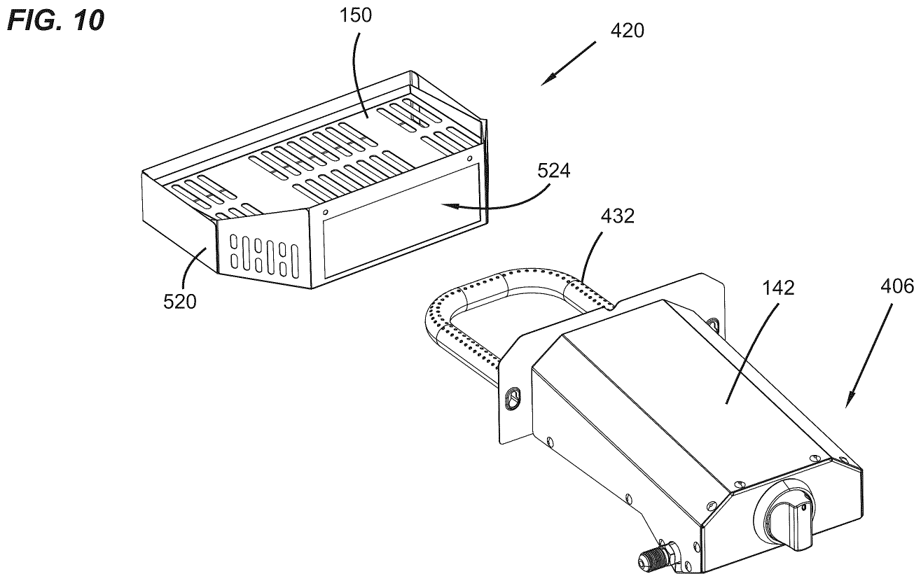

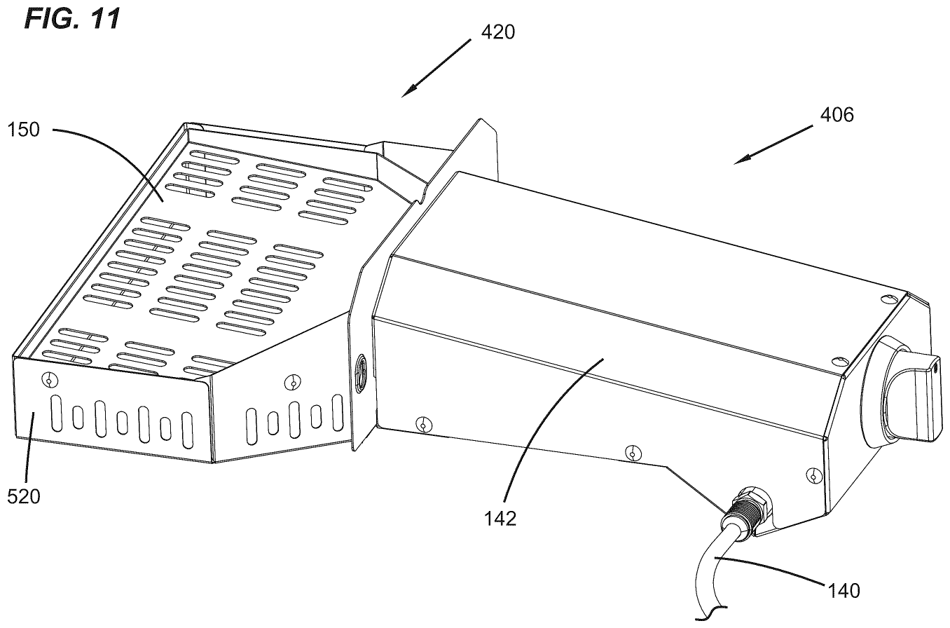

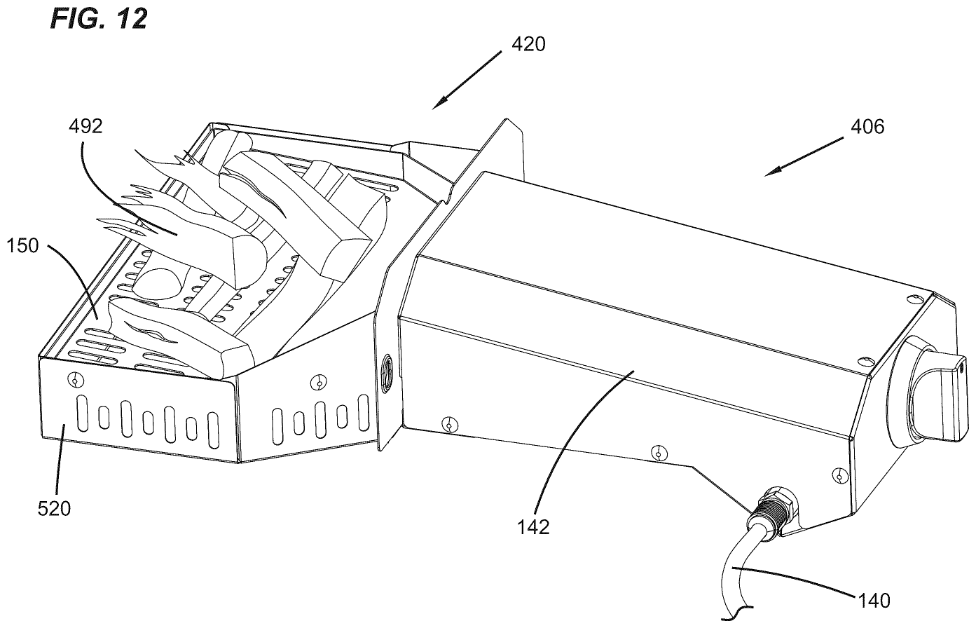

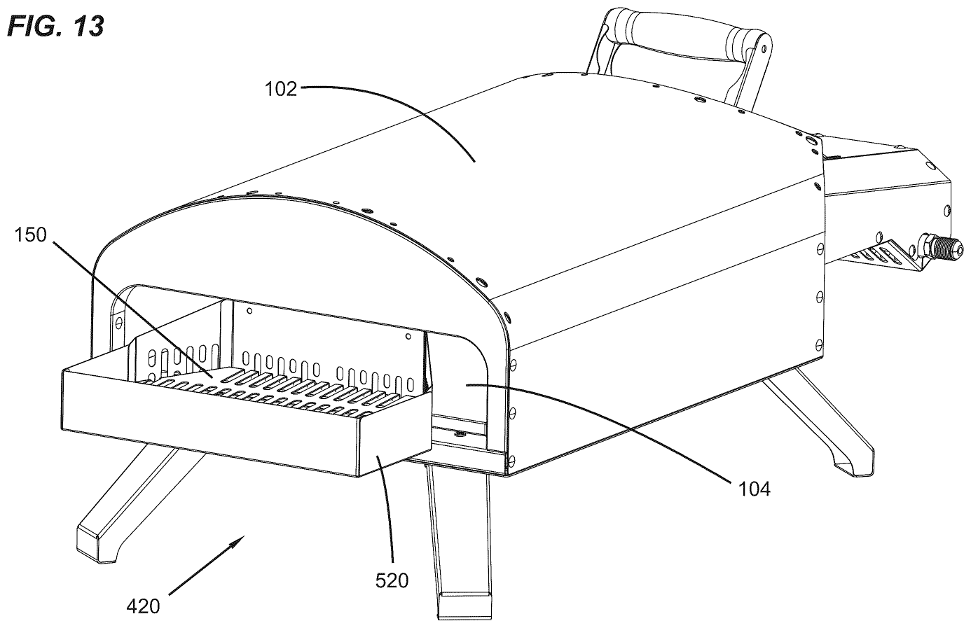

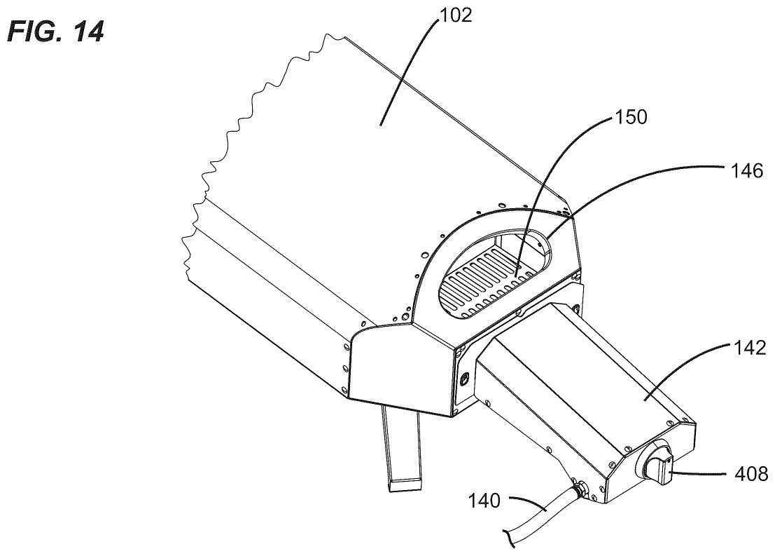

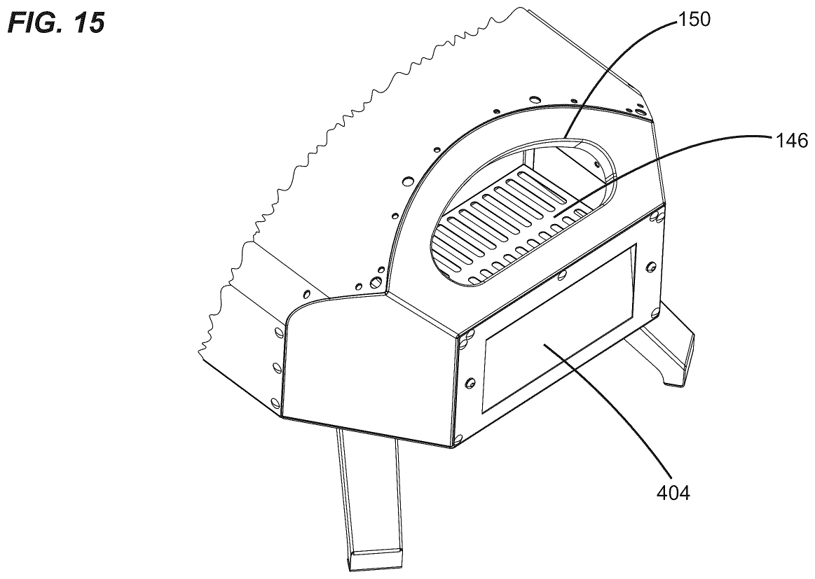

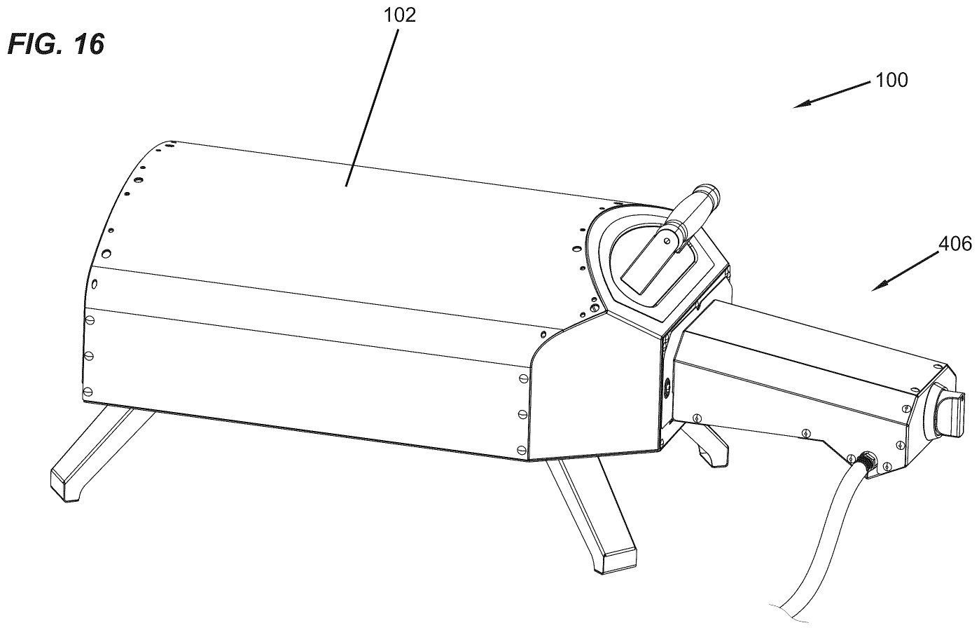

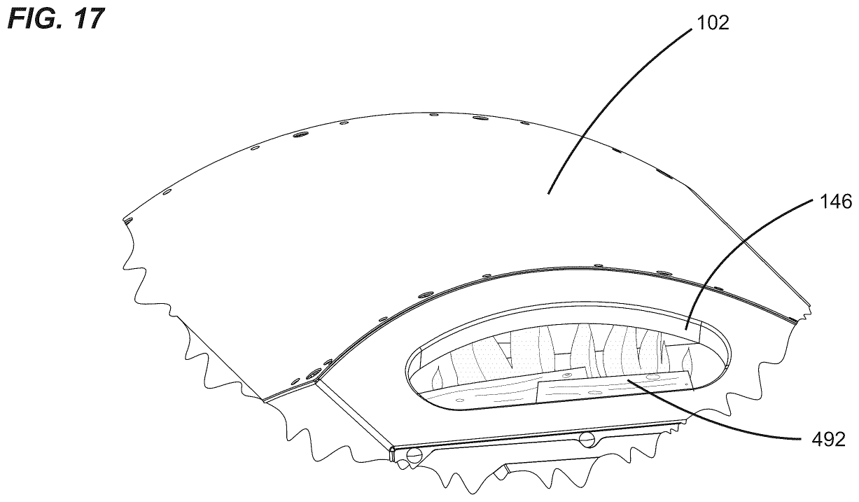

Referring now to FIGS. 4-17, in the example depicted, the oven 100 is fueled by both a gas burner 406 and wood held by a wood burning tray assembly 420. Specifically, heat from the gas burner 406 heats the oven 100 and ignites wood 492 on the wood burning tray assembly 420.

In this example, a Neapolitan style pizza 490 (or other food item) is positioned on a removable baking stone 402 (e.g., made of cordierite) within the oven 100. The heat generated by the gas burner 406 and the burning wood 492 held by the wood burning tray assembly 420 increases the temperature of the cooking cavity 482 to a desired temperature (e.g., approx. 900+ degrees Fahrenheit) to cook the Neapolitan style pizza 490 in a short amount of time (e.g., approx. 90 seconds).

More specifically, the oven 100 is heated from the back by the gas burner 406 and the burning wood 492 positioned on the wood burning tray assembly 420. The heat and smoke rise to a ceiling 460 of the oven 100, then moves towards a front cooking area 462 of the cooking cavity 482, where the Neapolitan style pizza 490 is positioned.

In this example, there is no door on the front of the body 102 to close a front opening 104. This front opening 104 acts as the exhaust for the heat and smoke from burning fuel sources. This front opening 104 draws the heat from the back of the oven to the front cooking area 462.

A front ledge 466 is formed below the ceiling 460 of the oven 100 that causes some of the heat from the gas burner 406 and burning wood 492 held by the wood burning tray assembly 420 to reflect downwards and convection/circulate through the oven 100. This heats up the removable baking stone 402 to allow the bottom of the Neapolitan style pizza 490 to cook evenly with the top part of the Neapolitan style pizza 490. Further, smoke from the burning wood 492 is directed along a similar path add the desired smoky flavor to the Neapolitan style pizza 490.

The wood burning tray assembly 420 includes a top grate 510 and an ashtray 520. As noted, the wood burning tray assembly 420 generally holds burning wood 492 positioned within the cooking cavity 482 of the oven 100.

The top grate 510 generally supports wood 492 positioned on the top grate 510 and includes openings 512 to allow air to circulate around for combustion and ash to fall into the ashtray 520. The top grate 510 also includes a lip 514 to generally maintain the wood on the top grate 510.

The ashtray 520 of the wood burning tray assembly 420 includes sides 522 with openings 606 to allow for airflow therethrough for combustion. Pegs 710 are positioned about the sides 522 to engage and hold the top grate 510 in position on top of the ashtray 520, as shown.

The ashtray 520 also includes an opening 524 through which a portion of the gas burner 406 is positioned, as described further herein. The sides 522 and a bottom 610 of the ashtray 520 form an interior space 602 where combustion of the gas by the gas burner 406 occurs. In addition, ash from the burning wood 492 on the top grate 510 falls (e.g., through the openings 512) and is maintained in the ashtray 520 for easier disposal later.

A flame guard 720 is formed as one of the sides 522 of the ashtray 520 facing the cooking area 462. The flame guard 720 is generally solid and forms a substantial barrier between the hot gas burner 406 and the Neapolitan style pizza 490 so that a crust of the Neapolitan style pizza 490 closest to the gas burner 406 does not burn.

The gas burner 406 is generally positioned through an opening 404 at the back of the oven 100. The gas burner 406 includes a main body 412 that controls the gas burner 406. The main body 412 is connected by a hose barb 810 and through a hose 410 to a source of gas, such a propane. A control knob 408 can be rotated to turn on and off the flow of gas to a gas burner tube 432 coupled to the main body 412 of the gas burner 406.

The burner tube 432 is perforated with holes through which the gas (e.g., propane) flows for combustion. In position within the opening 404 of the oven 100, the burner tube 432 extends through the opening 524 of the wood burning tray assembly 420 and into the interior space 620 where combustion occurs to heat the oven 100 and ignite/burn the wood 492 on the grate 510 of the wood burning tray assembly 420.

The oven 100 is generally assembled as follows. The oven 100 is placed outside (or in a structure with proper ventilation) on a level surface. With the baking stone 402 removed, the wood burning tray assembly 420 is inserted through the front opening 104 of the oven 100 and pushed to the back.

The gas burner 406 is then inserted through the opening 404 at the back of the oven 100 so that the burner tube 432 extends through the opening 524 of the wood burning tray assembly 420 and into the interior space 620. The main body 412 of the gas burner 406 can be affixed to the oven 100 in this position using one or more fasteners (e.g., bolts).

The hose 410 is then attached to a source of gas, such as a propane tank. The control knob 408 can be actuated (e.g., pushed in and rotated) to turn on the flow of gas to the burner tube 432 coupled to the main body 412 of the gas burner 406. An automatic igniter 812 can be actuated by holding in the control knob 408 for a specified period (e.g., 5 seconds). Gas flowing through the burner tube 432 is thereby ignited.

The flame from the gas burner 406 will heat up the cooking cavity 482 of the oven 100 to the desired temperature. A short time (e.g., about 5 minutes) before the Neapolitan style pizza 490 is introduced, small pieces of dry wood 492 are added to the top grate 510 through an access hatch 416 in the back of the oven 100. The flame from the gas burner 406, which is positioned adjacent to (e.g., below) the top grate 510 ignites the wood 492. The hatch door 418 can be placed to close the access hatch 416 to allow the heat and smoke to be circulated to the front of the oven 100 as described herein. The user can periodically remove the hatch door 418 using a handle 1810 to add more wood 492, as needed.

The Neapolitan style pizza 490 can thereupon be positioned on the baking stone 402 within the cooking cavity 482 to rapidly cook the pizza in as little as about 90 seconds.

As the wood 492 burns, the ash from the wood 492 falls onto the bottom 610 of the ashtray 520 within the interior space 602. The ash can easily be removed once the oven 100 cools by disconnecting the gas burner 406 and sliding the wood burning tray assembly 420 out of the front opening 104.

The majority of the components of the oven can be made from stainless or similar materials that are assembled to form the oven, including the gas burner and the wood burning tray assembly. The size and/or shape of each component can be modified from that depicted and still function in a similar way.

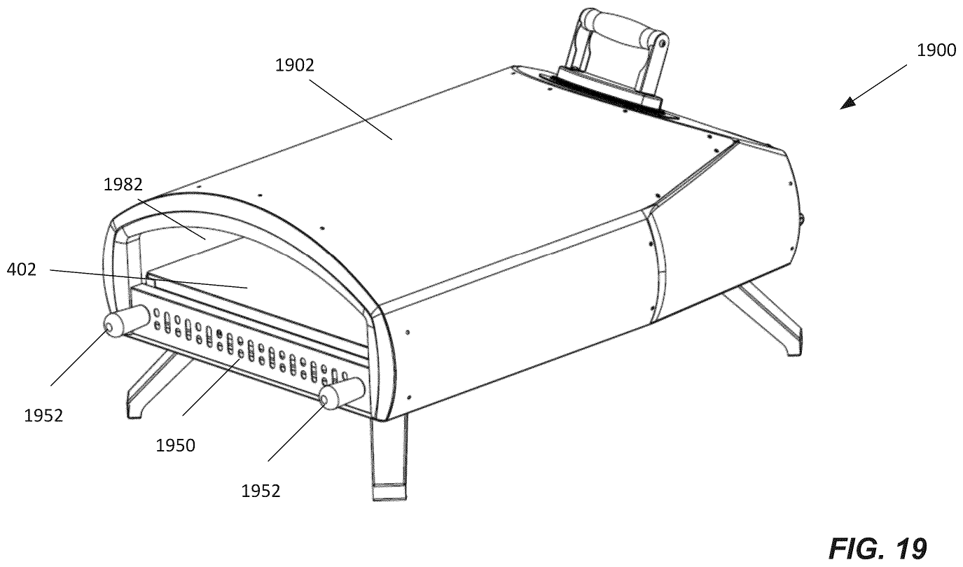

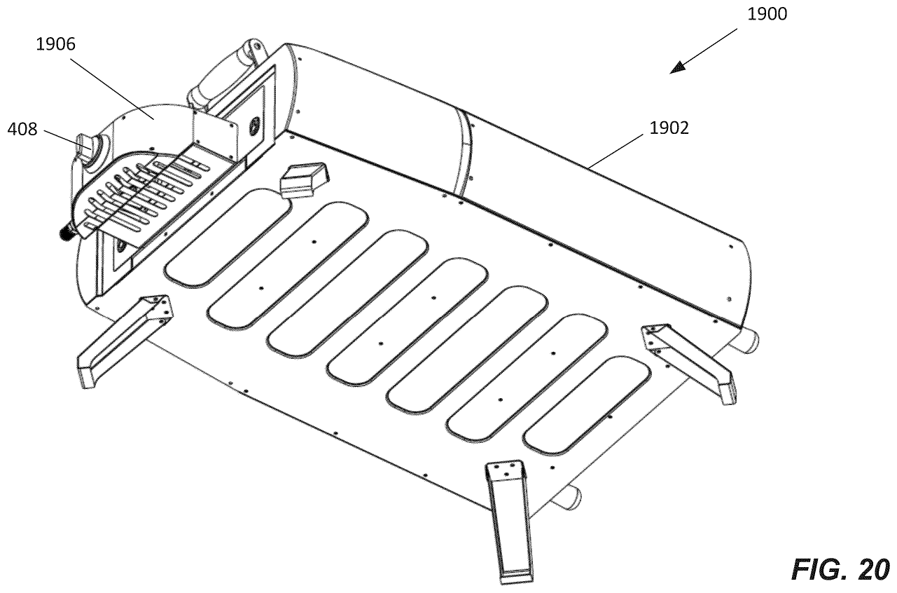

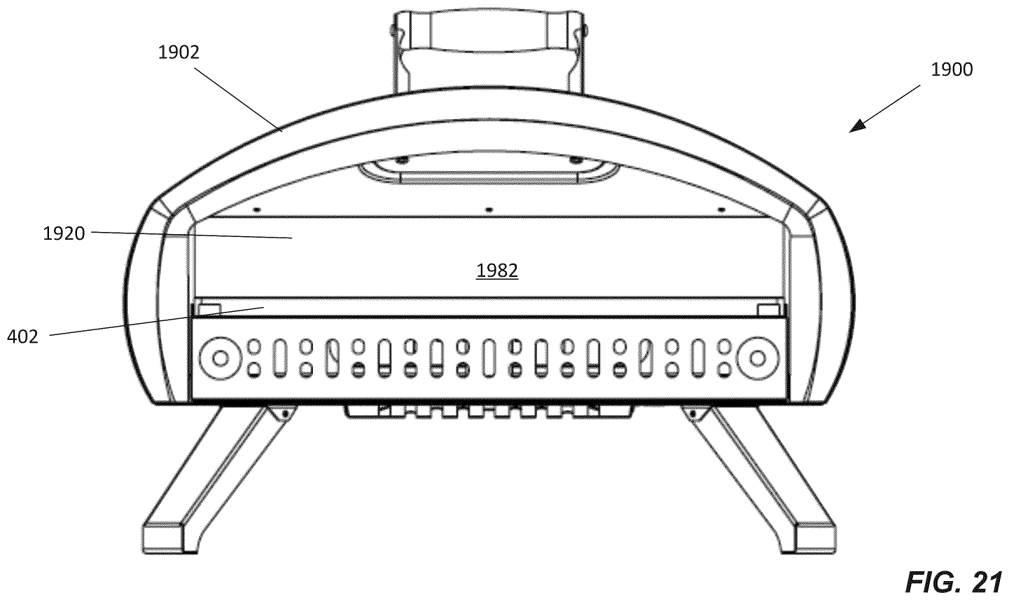

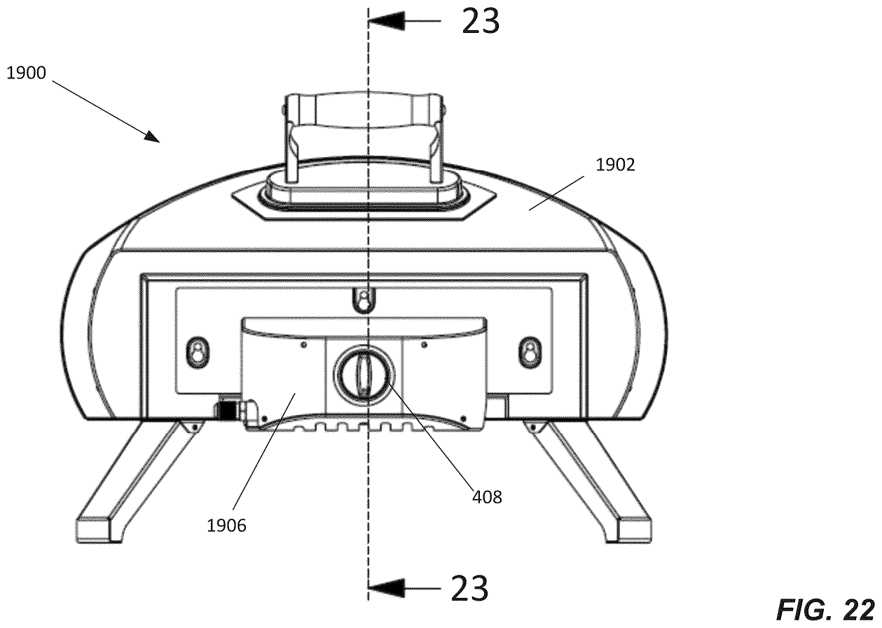

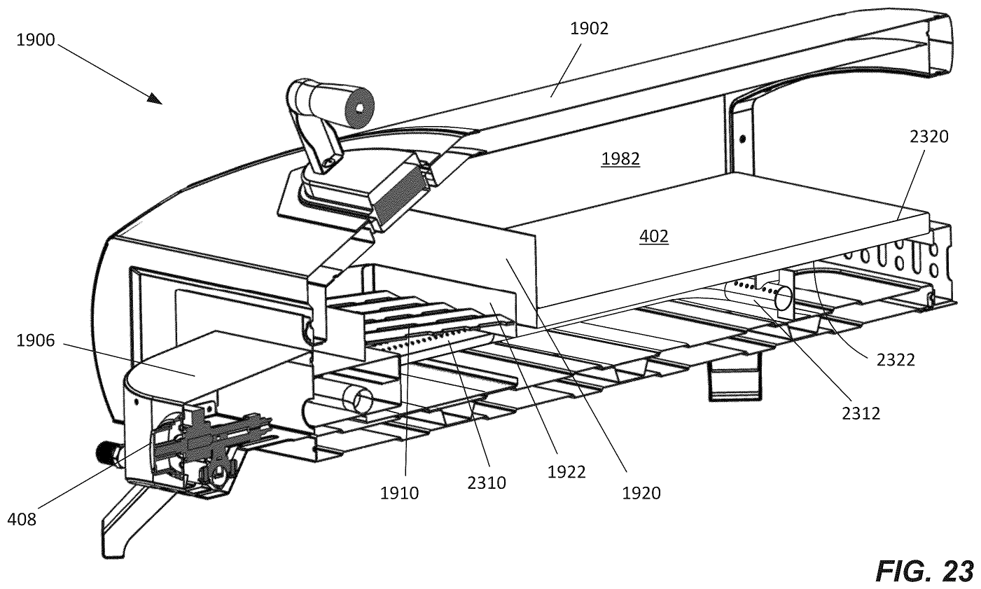

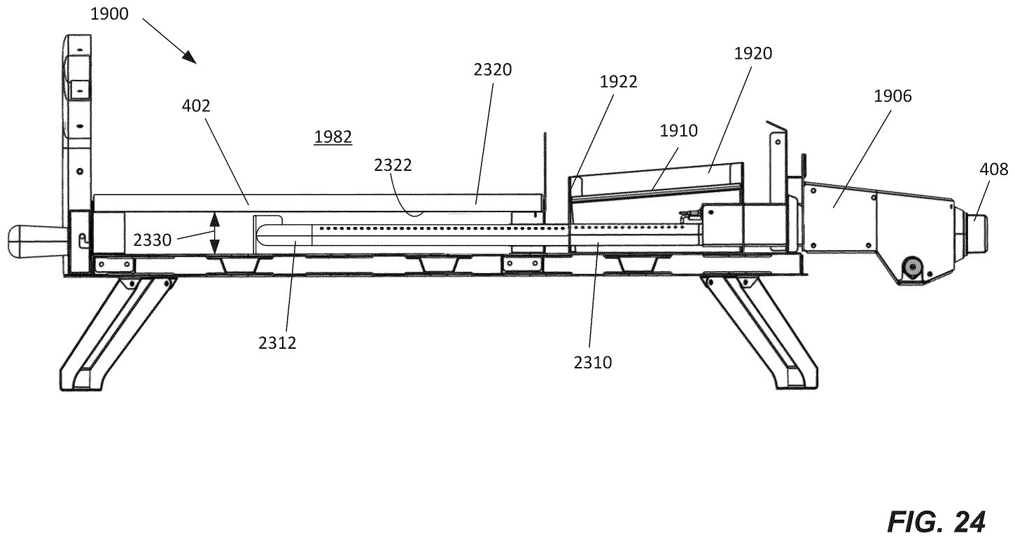

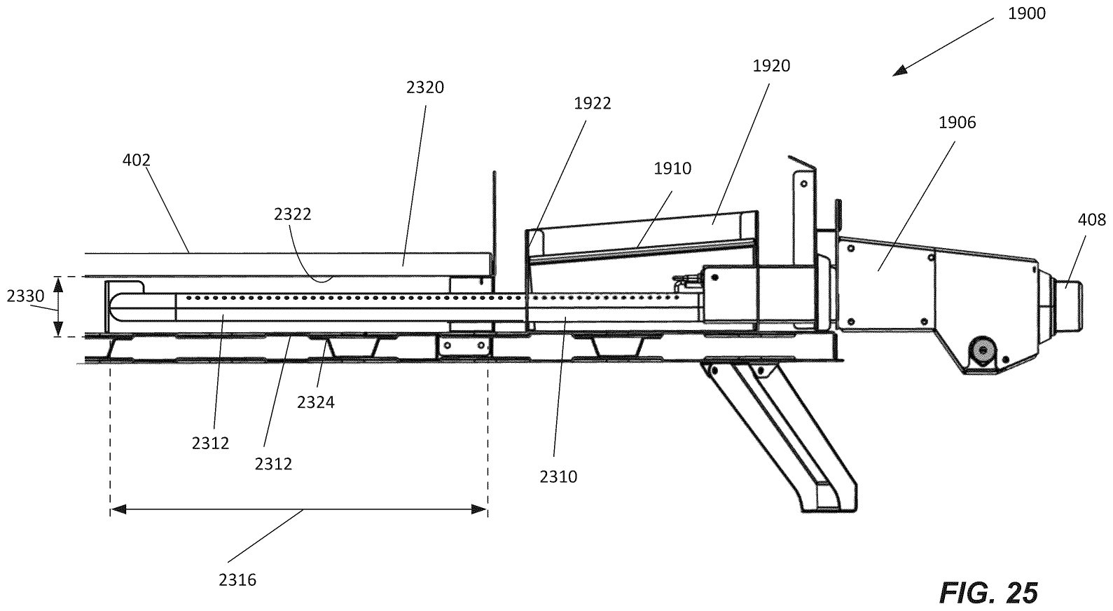

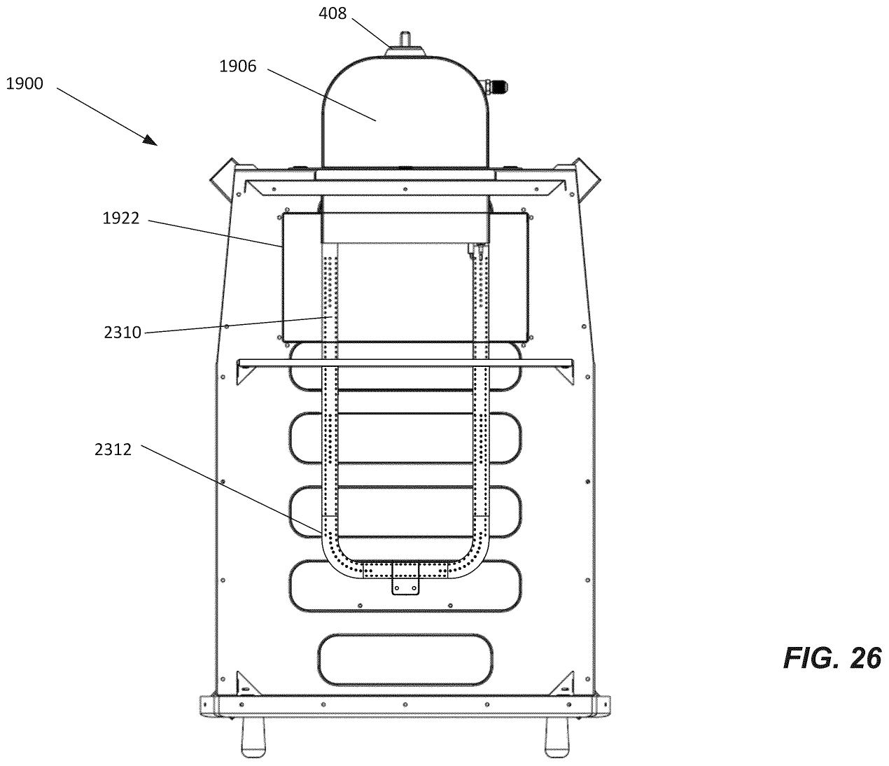

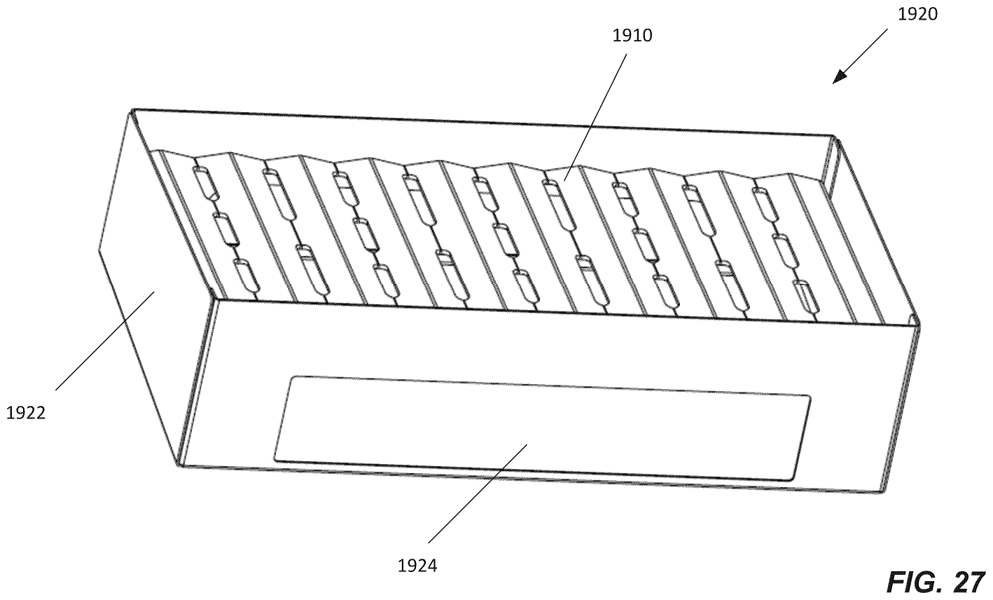

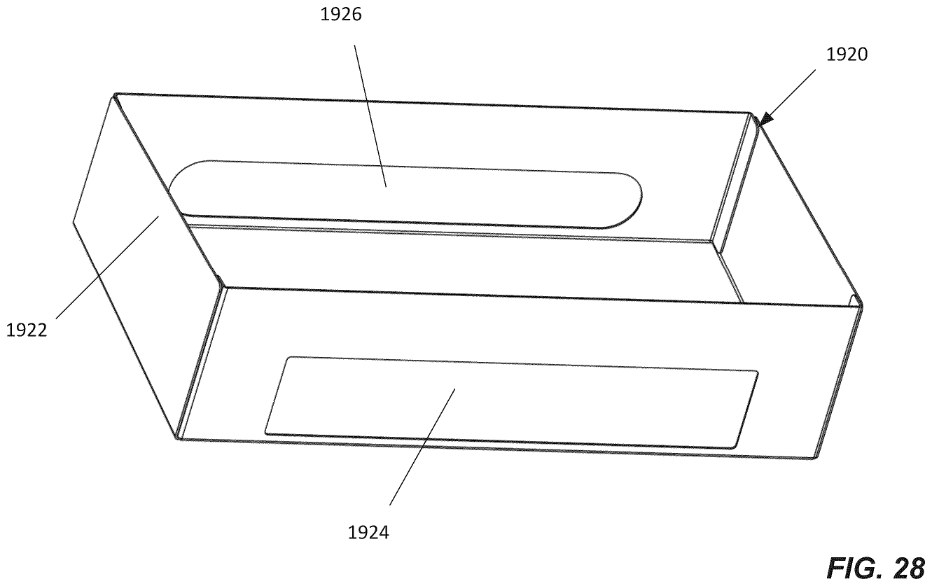

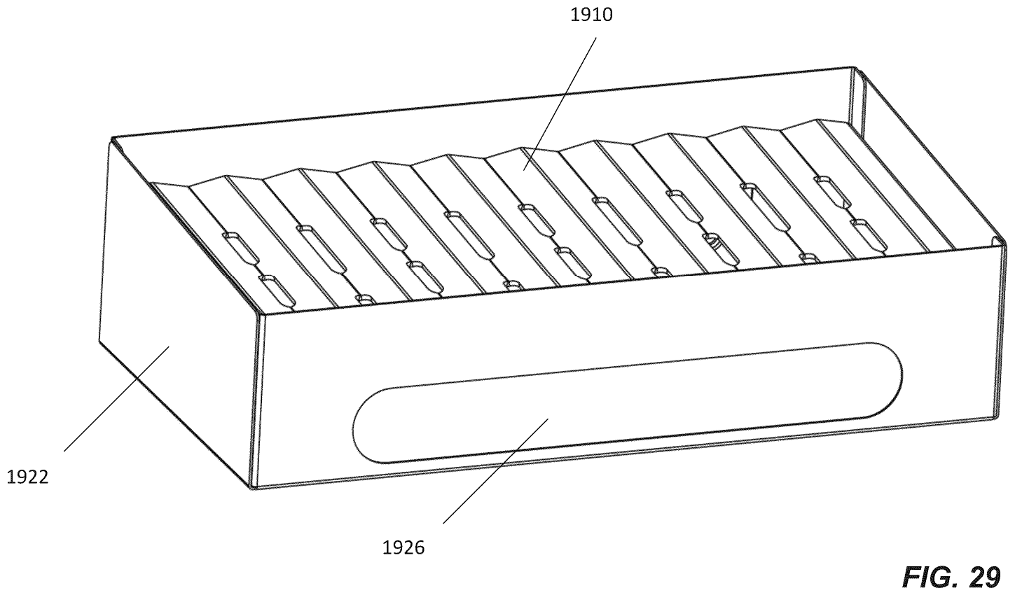

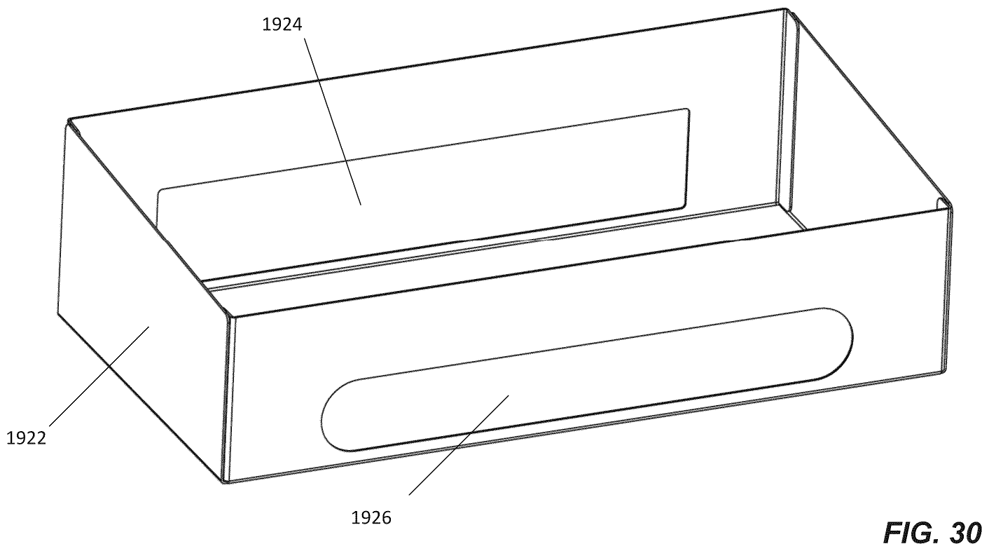

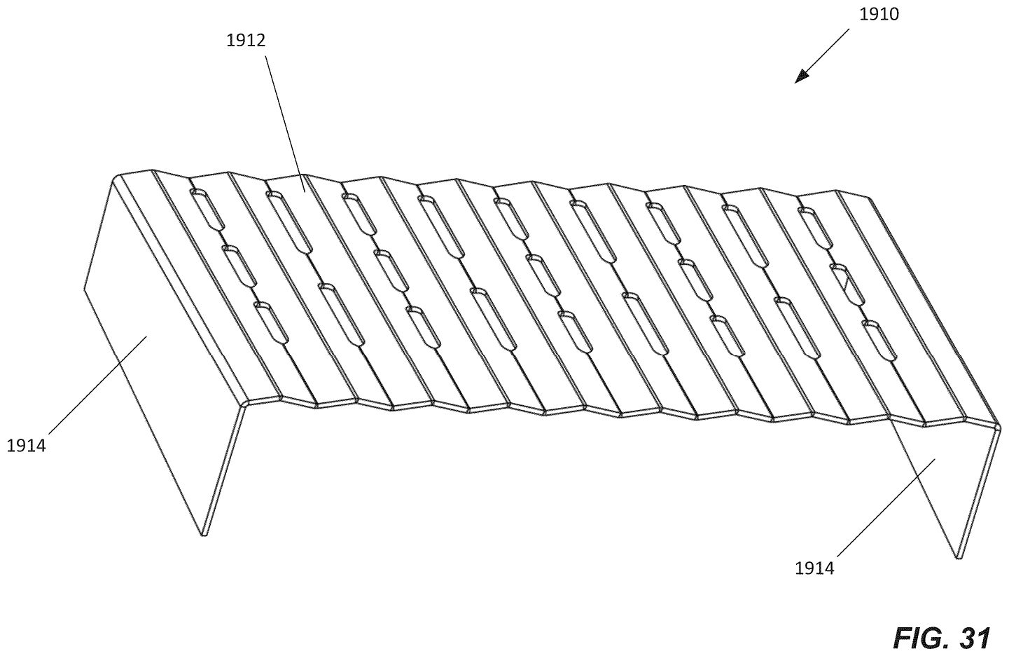

Referring now to FIGS. 19-31, another example oven 1900 with a body 1902 forming cooking cavity 1982 is shown. The oven 1900 is similar to the oven 100 described above, in that the oven 1900 is fueled by both a gas burner 1906 and wood held by a wood burning tray assembly 1920.

Specifically, heat from the gas burner 1906 heats the oven 1900 and ignites wood on a grate 1910 of the wood burning tray assembly 1920. The grate 1910 includes a surface portion 1912 with openings, upon which the wood sits. The grate 1910 also includes leg portions 1914 that are positioned within an ashtray 1922 of the wood burning tray assembly 1920 to elevate the surface portion 1912 within the ashtray 1922.

The ashtray 1922 of the wood burning tray assembly 1920 also includes an opening 1924 through which a burner tube 2310 of the gas burner 1906 is positioned, similar to the oven 100 above. However, unlike the oven 100 above, the ashtray 1922 of the oven 1900 further includes another opening 1926 opposite the opening 1924 sized to allow a portion 2312 of the burner tube 2310 to extend.

More specifically, the portion 2312 of the burner tube 2310 extends from the opening 1926 of the ashtray 1922 to underneath along a portion 2320 of the removable baking stone 402 (which is approximately 16 inches in length). In the example shown, the portion 2312 of the burner tube 2310 extends a distance 2316 of approximately 8.5 inches along the portion 2320. This is approximately one-half the length of the baking stone 402. In alternative designs, the distance 2316 can be shorter or longer, such as equal to about 1 inch, 16 inches (i.e., full length of the baking stone 402), or any distance therebetween.

In this configuration, the baking stone 402 is elevated from a lower surface 2324 of the oven 1900 a distance 2330 of 1.5 inches to allow the portion 2312 to extend underneath. When the gas burner 1906 is ignited, the portion 2312 of the burner tube 2310 directly heats a lower surface 2322 of the portion 2320 of the removable baking stone 402.

Heating of the baking stone 402 directly by the portion 2320 can allow the baking stone 402 to heat more quickly. Further, the temperature of the baking stone 402 can be controlled more directly by setting a desired temperature based upon the setpoint of the gas burner 1906 (e.g., rotating the control knob 408 to turn on and off the flow of gas to the burner tube 2310). This, in turn, allows for the Neapolitan style pizza (or other food item) positioned on the baking stone 402 to bake more quickly, along with other heat provided by the remainder of the burner tube 2310 and any heat and smoke optionally generated by wood held by a wood burning tray assembly 1920.

The oven 1900 also includes a grate/door 1950 is positioned to cover the gap (distance 2330) between the lower surface 2324 of the oven 1900 and the baking stone 402. The grate/door 1950 includes openings to allow ventilation and air flow to the gas burner 1906 below the stone baking stone 402. The grate/door 1950 also includes handles 1952 that allow the grate/door 1950 to be grasped and pulled out of the oven 1900 to access the gap for cleaning purposes.

In alternative designs, the gas burner tube can be positioned differently. For instance, in other designs, the gas burner tube can be configured to extend further underneath the baking stone to cover a greater portion of the baking stone. In yet other examples, the gas burner tube can be repositioned to heat other portions of the baking stone, such as the upper surface or end surface. In yet other designs, the portion of the burner below the baking stone can be controlled independently from the portion of the burner located within the ashtray. For instance, the size of the flame under the baking stone can be controlled separately from the size of the flame within the ashtray. Other configurations are possible.

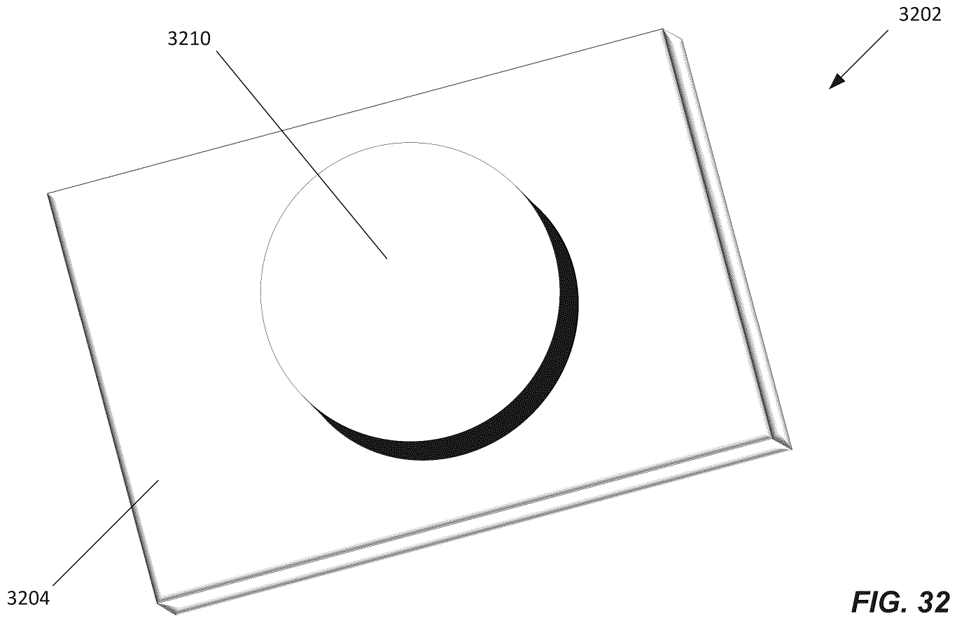

Referring now to FIG. 32, another example baking stone 3202 is shown. In this example, the baking stone 3202 includes a rotating portion 3210 that can rotate relative to a main body 3204 of the baking stone 3202. This can be advantageous, for instance, to cook the food item (e.g., pizza) more evenly as the food item sits upon and is rotated by the rotating portion 3210 during cooking in the oven 1900.

The rotating portion 3210 can be made of the same material as the main body 3204 of the baking stone 3202 or another material. The rotating portion 3210 is coupled to the main body 3204 and rotates relative thereto. For instance, lubrication or ball bearings can be used to allow for easier movement of the rotating portion 3210 relative to the main body 3204.

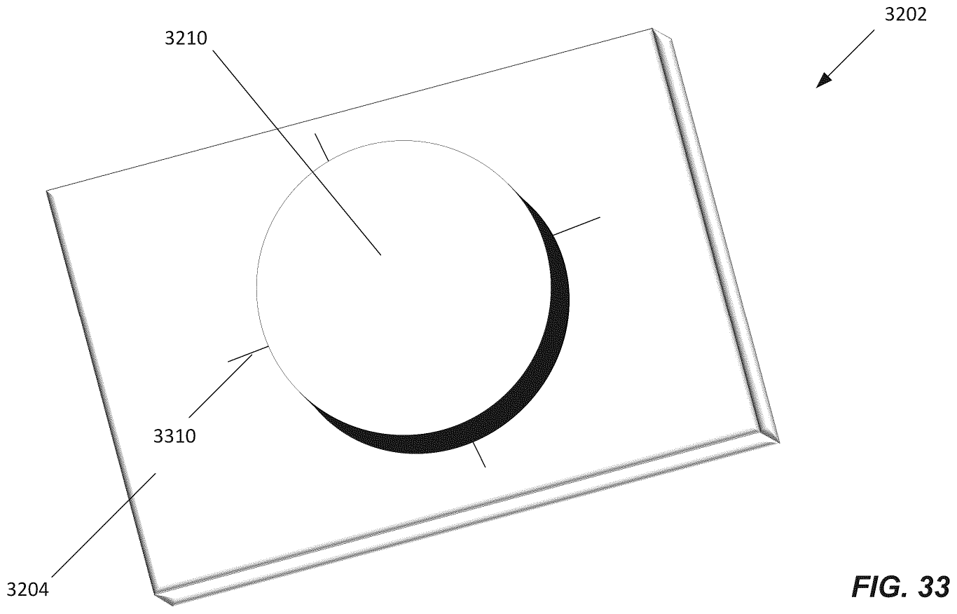

In some examples, the rotating portion 3210 can be rotated manually. For instance, as shown in FIG. 33, the example rotating portion 3210 can include extended portions 3310 extending radially outward from the rotating portion 3210 at periodic intervals along the circumferential edge of the rotating portion 3210. This allows the user to easily spin the rotating portion 3210 by engaging one of the extended portions 3310 with, for instance, a spatula or other tool, during cooking. Other configurations (e.g., notches) and/or ways to manually spin the rotating portion 3210 are possible.

In other examples, the rotating portion 3210 can automatically spin. For instance, the rotating portion 3210 can be spring-loaded so that it can be wound before being placed within and heated by the oven 1900. The spring can slowly uncoil and rotate the rotating portion 3210 during cooking. In another example, a thermoelectric generator or other source of electricity (e.g., battery or mains power) can be used to power a small motor that is configured to rotate the rotating portion 3210. Other configurations are possible.

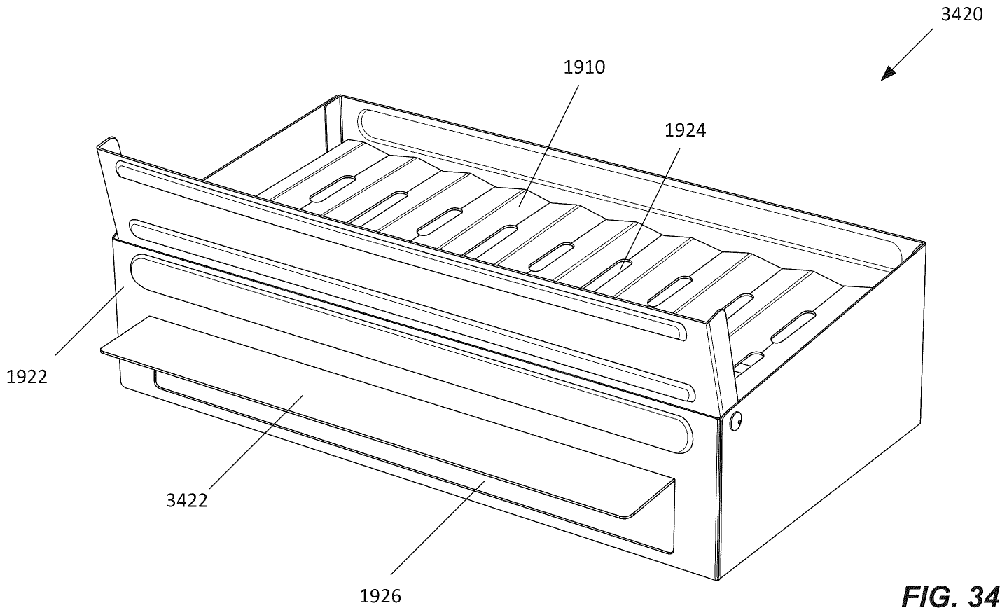

Referring now to FIG. 34, another example wood burning tray assembly 3420 for the oven 1900 is shown. The wood burning tray assembly 3420 is similar to that of the wood burning tray assembly 1920 described above, including the grate 1910 upon which the wood sits, the ashtray 1922, and openings 1924, 1926 through which a burner tube 2310 of the gas burner 1906 extends.

The wood burning tray assembly 3420 also includes a horizontal flange 3422 extending from the ashtray 1922 above the opening 1926 through which the burner tube 2310 extends to underneath along the portion 2320 of the removable baking stone 402.

The flange 3422 covers any gap between the wood burning tray assembly 3420 and the removable baking stone 402. This mitigates any flame from the burner tube 2310 that might extend through that gap and adjacent to a food item on the removable baking stone 402. Specifically, the flange 3422 stops any flame from extending up from that gap and burning the food item. Other configurations are possible.

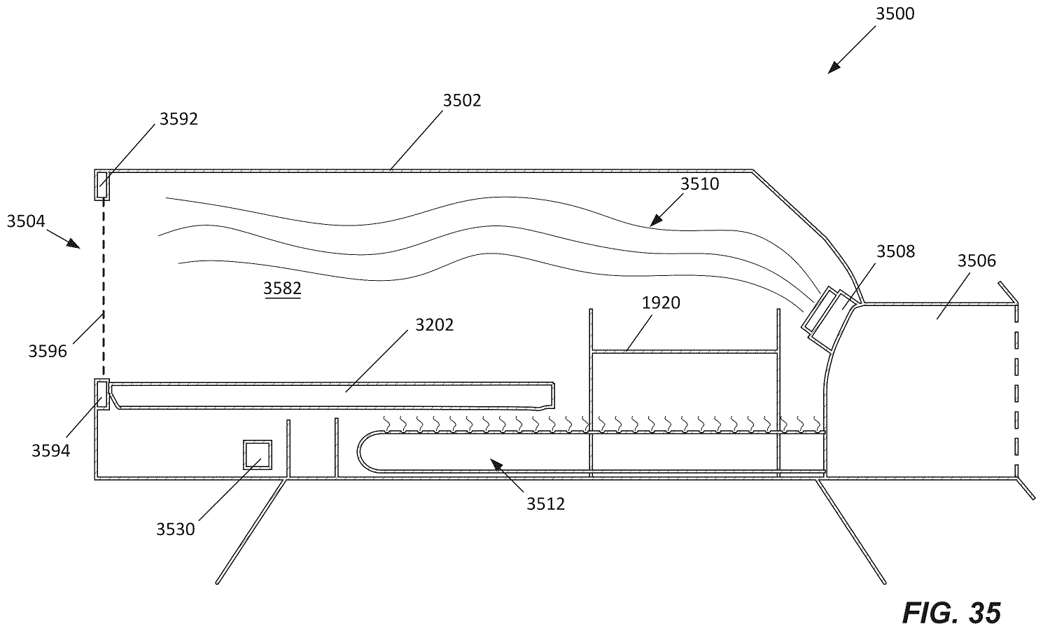

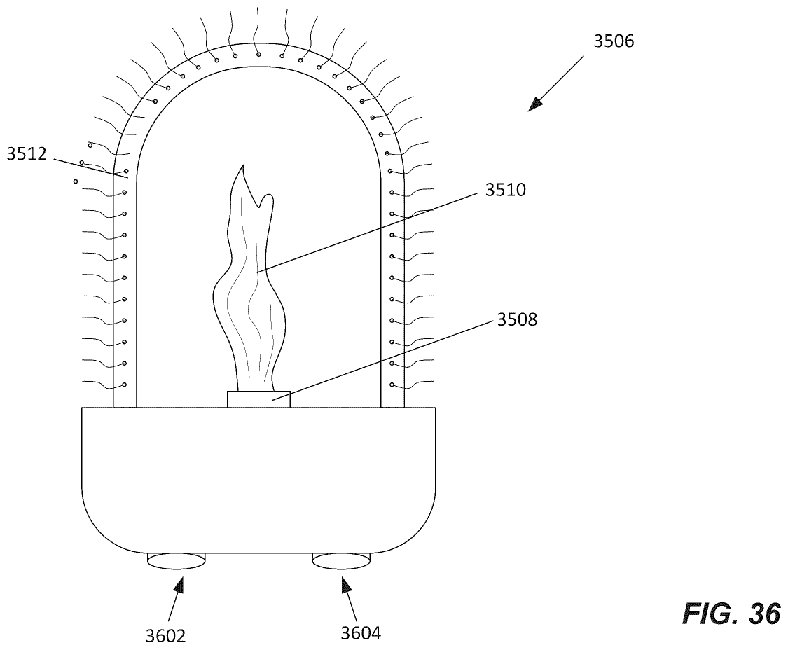

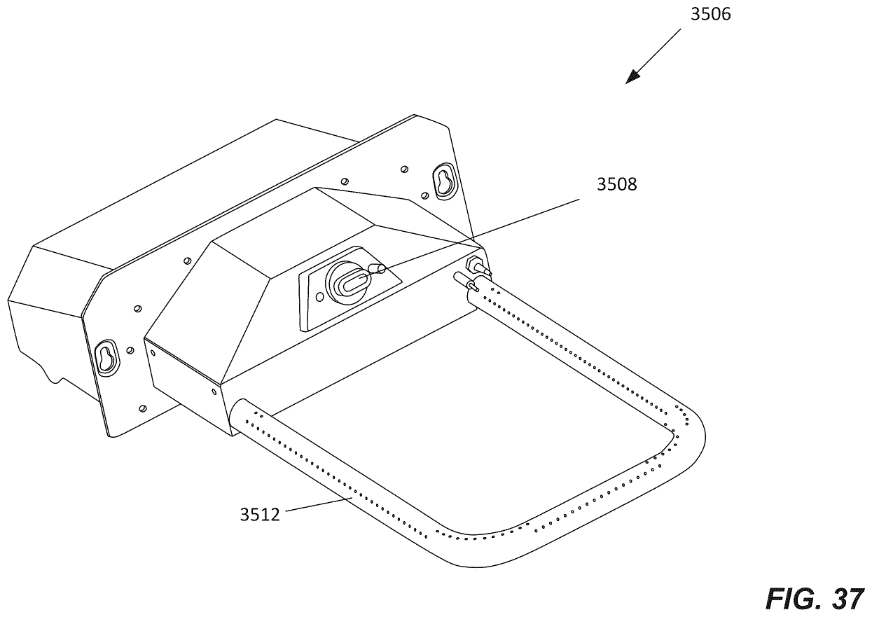

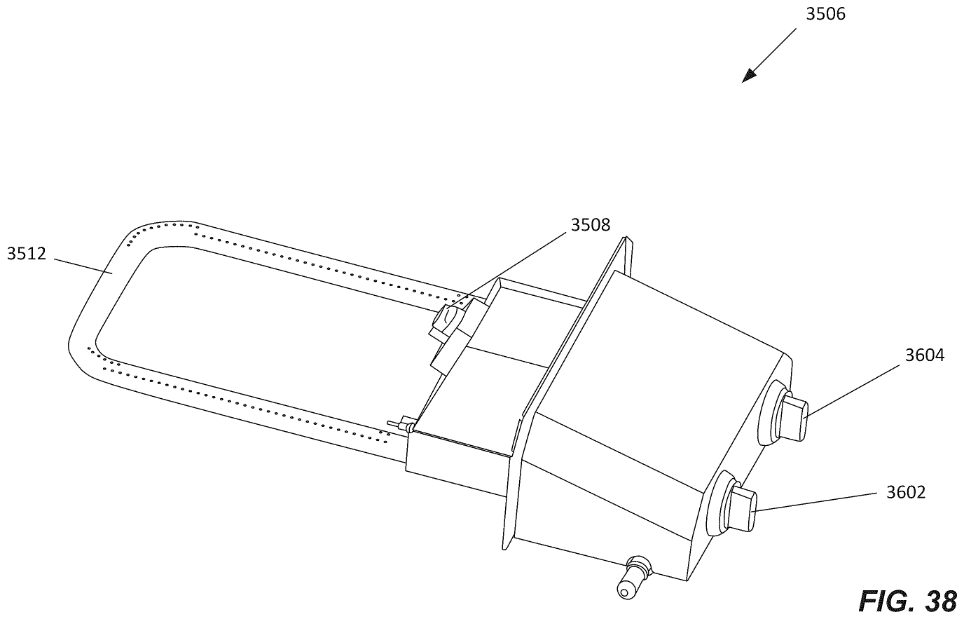

Referring now to FIGS. 35-38, another example oven 3500 with a body 3502 forming cooking cavity 3582 is shown. The oven 3500 is similar to the ovens 100, 1900 described above, in that the oven 3500 is fueled by both a gas burner 3506 and wood held by a wood burning tray assembly 1920. Alternatively, the oven 3500 can be solely a gas-powered oven in other embodiments.

The example gas burner 3506 includes two separately-controlled gas elements, each with their own on/off knob, which will be adjustable. This dual-burner design includes a lower burner tube 3512 that is positioned to heat the baking stone 3202 from below and also ignite the wood in the wood burning tray assembly 1920. The dual-burner design also includes an upper gas tube 3508 that is positioned to create a rolling gas flame 3510 from above, which will cook the top of the pizza on the baking stone 3202. In example embodiments, the rolling gas flame 3510 extends into a center area above the pizza on the baking stone 3202 to cook the top of the pizza from the center of the pizza outward to the crust.

These two gas burner tubes 3512 and 3508 work together, one heating from below, the second from above. The gas burner tubes 3512 and 3508 can be individually controlled by the user. For instance, the gas burner 3506 includes an example control knob 3602 that is rotatable to control the upper gas tube 3508 and another example control knob 3604 that is rotatable to control the lower burner tube 3512.

For instance, when the control knob 3602 rotates in a first direction, the rolling gas flame 3510 from the upper gas tube 3508 increases as the flow of gas increases. Similarly, as the control knob 3602 rotates in the opposite direction, the rolling gas flame 3510 decreases and is eventually extinguished. Similar controls are applicable to the control knob 3604.

In one example, when the oven 3500 is used without wood, the rolling gas flame 3510 from the upper gas tube 3508 is utilized to cook the upper portion of the pizza, and the flame from the lower burner tube 3512 is used to heat the baking stone 3202 to cook the lower surface (e.g., crust) of the pizza. In some examples, the upper gas tube 3508 is positioned at a specific angle to direct the rolling gas flame 3510 towards the upper portion of the cooking cavity 3582 above the upper portion of the pizza. This can be a variety of angles, such as 30 degrees, 45 degrees, and/or 60 degrees, from a horizontal axis of the oven 3500.

In some examples, the angle of the upper gas tube 3508 is selected so that the rolling gas flame 3510 will ignite or otherwise impinge on wood that is positioned on the wood burning tray assembly 1920 as the rolling gas flame 3510 exits the upper gas tube 3508 and moves to the upper portion of the cooking cavity 3582. This configuration can thereby assist in igniting the wood and assist in carrying the smoky flavor of the wood into the cooking cavity 3582. Alternatively, when wood is used in conjunction with the wood burning tray assembly 1920, use of the rolling gas flame 3510 from the upper gas tube 3508 can be minimized or eliminated, since the flame from the burning wood can create the rolling flame across the top of the pizza. Many configurations are possible.

As noted, the oven 3500 can be used with both gas-only and wood/gas configurations to cook pizza. Further, the baking stone 3202 can be configured to rotate or not to rotate as desired. In a non-rotating version, the lower burner tube 3512 can be configured to extend substantially underneath an entire length of the baking stone 3202 to allow the baking stone 3202 to be heated evenly. In an example rotating version as depicted in FIGS. 35-38, the lower burner tube 3512 can only extend substantially halfway underneath the baking stone 3202, since the baking stone 3202 rotates above the lower burner tube 3512 to be heated evenly. Many other configurations are possible.

In an optional embodiment, the oven 3500 can also include a temperature sensor 3530 located in the body 3502. The temperature sensor 3530 can be configured to measure a cooking temperature within the cooking cavity 3582 to allow for an easier determination of when to place the pizza within the oven 3500 and for how long to cook the pizza.

In one example, the temperature sensor 3530 is programmed to provide the temperature to an interface outside of the cooking cavity 3582, such as on the front control area of the oven 3500. In other embodiments, the temperature sensor 3530 can be programmed to provide the temperature wirelessly to a remote computing device, such as a smartphone. For instance, the temperature sensor 3530 can be connected through Bluetooth, Wi-Fi, or a similar wireless connection technology to allow a user to remotely monitor the temperature within the cooking cavity 3582. In some embodiments, other aspects of the oven 3500 could also be controlled, such as the control knobs 3602, 3604 to increase or decrease the heat within the cooking cavity 3582.

In another optional design, the oven 3500 can detect when a pizza is introduced into and removed from the oven 3500. For instance, the oven 3500 can include an emitter module 3592 and a receiver module 3594 located at a front opening 3504 of the oven 3500. The emitter module 3592 emits an invisible beam of light 3596 (e.g., infrared) that is received by the receiver module 3594.

When the beam of light 3596 is interrupted, such as by the introduction of the pizza into the oven 3500 or the removal of the pizza from the oven 3500 (e.g., when a spatula is introduced), the receiver module 3594 fails to receive the beam of light 3596. Upon this failure to receive the beam of light 3596, the receiver module 3594 trigger the baking stone 3202 to stop spinning. This can allow for easier placement of the pizza onto the baking stone 3202 and removal of the pizza from the oven 3500.

Once the pizza is placed upon the baking stone 3202 or removed from the oven 3500, the beam of light 3596 is uninterrupted and again received by the receiver module 3594. At this point, the receiver module 3594 can trigger the baking stone 3202 to being spinning again. Many other configurations are possible.

As with previous embodiments, the wood burning tray assembly 1920 may be accessible within the cooking cavity 3582 and removable from the oven 3500. For instance, the body 3502 of the oven 3500 can include a removable panel to allow for access to the wood burning tray assembly 1920.

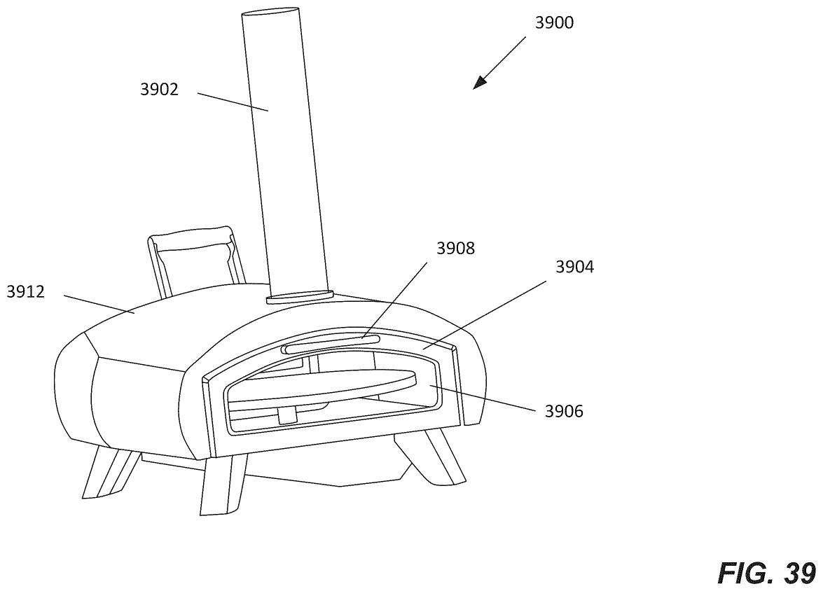

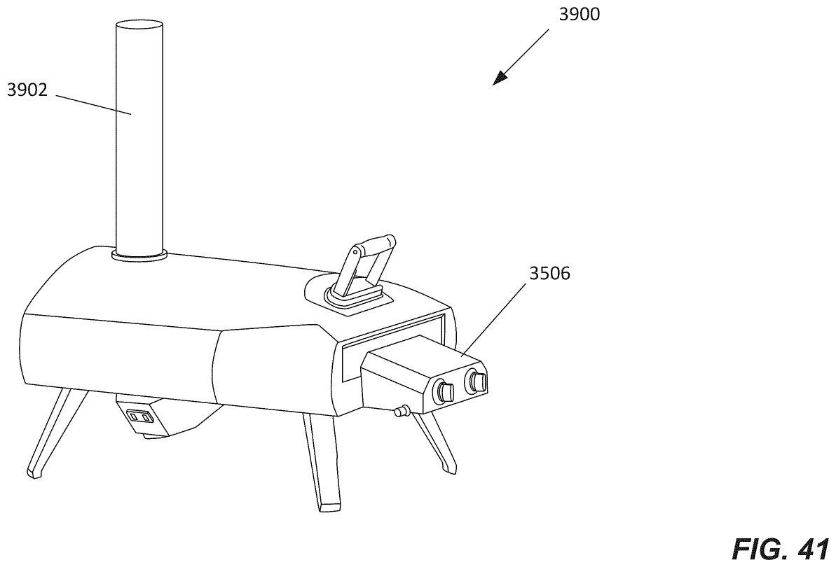

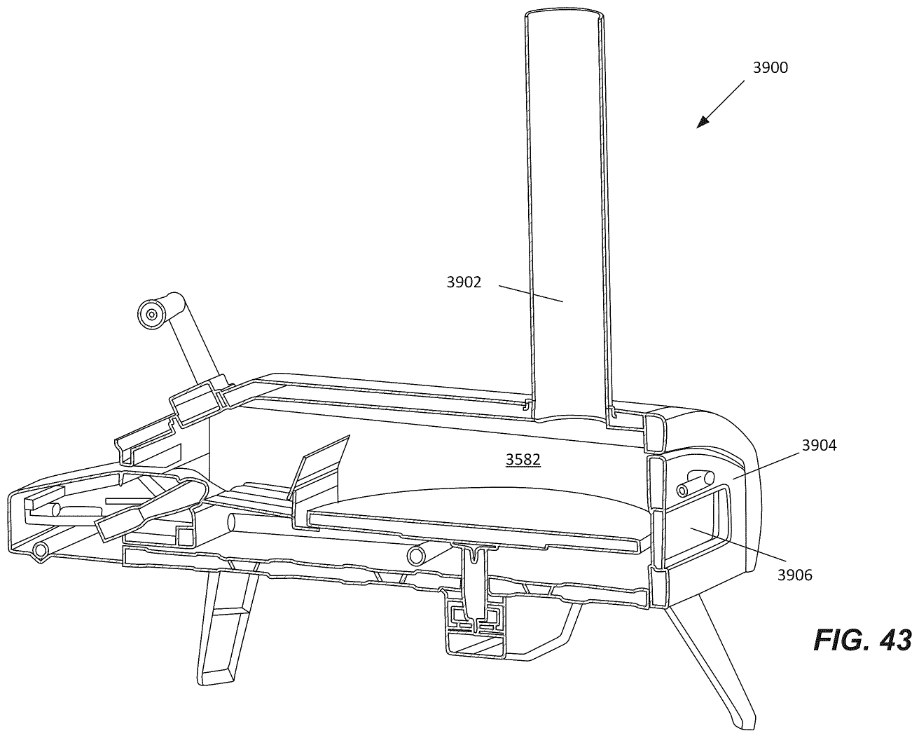

Referring now to FIGS. 39-43, another example oven 3900 is shown. The oven 3900 is similar to the ovens 100, 1900, 3500 described above, in that the oven 3500 is fueled by both a gas burner (dual, in this instance) and wood held by a wood burning tray assembly.

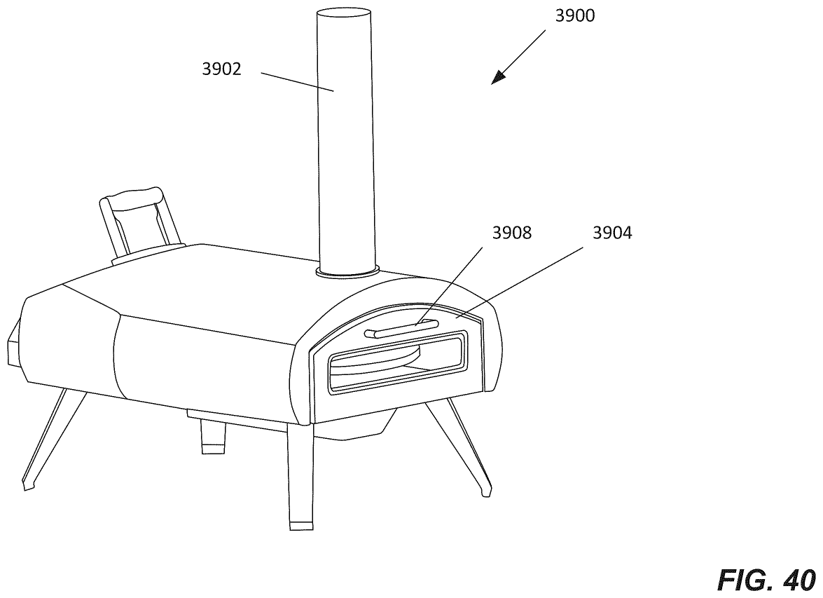

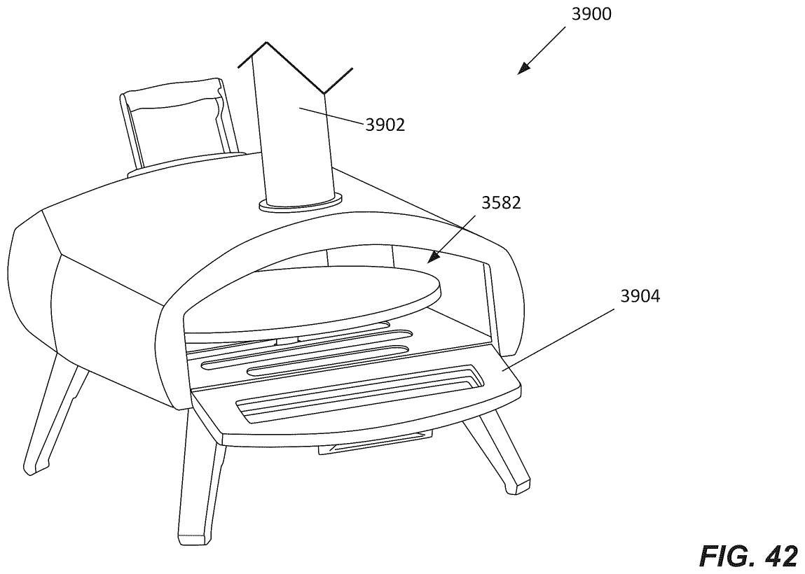

In optional embodiments, the oven 3900 can include a door 3904 positioned over the front opening of the oven 3900. For instance, the door could be partially translucent, such as including a glass portion 3906, to allow the user to see the pizza within the cooking cavity 3582. In these examples, the door 3904 is pivotable from a closed position (see FIGS. 39 and 40) to an open position (see FIG. 42) to allow for access to the pizza within the cooking cavity 3582. A handle 3908 is provided to allow the user to grasp and move the door 3904 from the closed to open positions and back.

Similarly, the oven 3900 could include one or more chimneys 3902 extending from a top of a body 3912 of the oven 3900 to allow for exhaust of the heated air and gas from the cooking cavity 3582 to the atmosphere. Many other configurations are possible.

What is claimed is:

1. An oven, comprising:
a main body defining a cooking cavity;
a front portion of the main body defining a front opening for receiving a pizza;
a baking stone positioned to support the pizza; and
a gas burner positioned adjacent to the baking stone;
wherein the gas burner includes a lower burner tube positioned to heat the baking stone; and
wherein the gas burner includes an upper burner tube positioned to create a rolling flame over a top portion of the pizza.

2. The oven of claim 1, further comprising a temperature sensor to sense a temperature of the cooking cavity.

3. The oven of claim 1, further comprising a sensor to detect when the pizza is introduced into and taken out of the cooking cavity.

4. The oven of claim 3, wherein the baking stone is configured to stop rotating when the sensor detects the pizza being introduced into and taken out of the cooking cavity.

5. The oven of claim 1, further comprising a door positioned to close an opening defined in the front portion of the main body.

6. The oven of claim 1, further comprising a chimney positioned on the main body to vent from the cooking cavity to atmosphere.

7. The oven of claim 1, further comprising a tray assembly including a grate positioned in the main body, wherein the lower burner tube is further positioned to ignite fuel on the grate of the tray assembly to further heat the cooking cavity.

8. The oven of claim 1, wherein the upper burner tube is individually controlled by a first control knob separate from a second control knob that controls the lower burner tube.

9. The oven of claim 1, wherein the rolling flame from the upper burner tube extends into a center area above the pizza to cook the top of the pizza from a center outward to a crust of the pizza.

10. The oven of claim 1, wherein the upper burner tube is configured to be minimized or deactivated when wood fuel is used in conjunction with a wood burning tray assembly to create the rolling flame over the top portion of the pizza.

11. A method of cooking a pizza, comprising:
providing an oven including a main body defining a cooking cavity and a front portion defining a front opening;
positioning a baking stone in the cooking cavity to support the pizza;
positioning a gas burner adjacent to the baking stone, wherein the gas burner includes a lower burner tube and an upper burner tube;
heating the baking stone using the lower burner tube; and
creating a rolling flame over a top portion of the pizza using the upper burner tube.

12. The method of claim 11, further comprising a temperature sensor to sense a temperature of the cooking cavity.

13. The method of claim 11, further comprising a sensor to detect when the pizza is introduced into and taken out of the cooking cavity.

14. The method of claim 13, wherein the baking stone is configured to stop rotating when the sensor detects the pizza being introduced into and taken out of the cooking cavity.

15. The method of claim 11, further comprising a door positioned to close an opening defined in the front portion of the main body.

16. The method of claim 11, further comprising a chimney positioned on the main body to vent from the cooking cavity to atmosphere.

17. The method of claim 11, further comprising a tray assembly including a grate positioned in the main body, wherein the lower burner tube is further positioned to ignite fuel on the grate of the tray assembly to further heat the cooking cavity.

18. The method of claim 11, wherein the upper burner tube is individually controlled by a first control knob separate from a second control knob that controls the lower burner tube.

19. The method of claim 11, wherein the rolling flame from the upper burner tube extends into a center area above the pizza to cook the top of the pizza from a center outward to a crust of the pizza.

20. An oven, comprising:
a main body defining a cooking cavity;
a front portion of the main body defining a front opening for receiving a pizza;
a baking stone positioned within the cooking cavity to support the pizza; and
a gas burner positioned adjacent to the baking stone;
wherein the gas burner includes a lower burner tube positioned to heat the baking stone;
wherein burner includes an upper burner tube positioned to create a rolling flame over a top portion of the pizza;
wherein the upper burner tube is individually controlled by a first control knob;
wherein the lower burner tube is individually controlled by a second control knob; and
wherein the rolling flame from the upper burner tube extends into a center area above the pizza to cook the top of the pizza from a center outward to a crust of the pizza.
